(19) United States
(12) Patent Application Publication
(10) Pub. No.: US 2025/0199392 A1
(43) Pub. Date: Jun. 19, 2025

(54) STEREOSCOPIC OPTICAL SYSTEM AND IMAGE PICKUP APPARATUS

(71) Applicant: CANON KABUSHIKI KAISHA, Tokyo (JP)

(72) Inventor: Natsuki ABE, Tokyo (JP)

(21) Appl. No.: 18/979,830

(22) Filed: Dec. 13, 2024

(30) Foreign Application Priority Data
Dec. 19, 2023 (JP) 2023-213506

(51) Int. Cl. G03B 35/10; G02B 13/00; H04N 13/229

(52) U.S. Cl. CPC G03B 35/10; G02B 13/0045; G02B 13/006; H04N 13/229

(57) ABSTRACT

A stereoscopic optical system includes two optical systems arranged in parallel. Each of the two optical systems includes an aperture stop and at least two positive lenses disposed on an image side of the aperture stop. Predetermined inequalities are satisfied.

### BACKGROUND

### Technical Field

The present disclosure relates to a stereoscopic optical system for stereoscopic imaging, and an image pickup apparatus having the same.

### Description of Related Art

In a stereoscopic optical system including two optical systems arranged in parallel with a base length as a distance between their optical axes, as the base length changes, a three-dimensional effect of an image to be stereoscopically viewed changes. Japanese Patent Laid-Open No. 2020-008629 discloses stereoscopic optical systems that accommodate two image circles formed by two optical systems within an imaging surface of a single image sensor.

The stereoscopic optical system disclosed in Japanese Patent Laid-Open No. 2020-008629 accommodates two image circles within a single imaging surface and secures a sufficient base length by using two reflective surfaces that bend the optical path in each of the two optical systems.

### SUMMARY

A stereoscopic optical system according to one aspect of the disclosure includes two optical systems arranged in parallel. Each of the two optical systems includes an aperture stop and at least two positive lenses disposed on an image side of the aperture stop. The following inequalities are satisfied:

$$1.8 \leq D / ( f tan ω ) ) \leq 5.5$$

$$2. \leq L / f \leq 5.5$$

where D is a distance between optical axes of the two optical systems, f is a focal length of each of the two optical systems, ω is a maximum half angle of view of each of the two optical systems, and L is a distance on an optical axis from a surface closest to an object of each of the two optical systems to an image plane. An image pickup apparatus having the above stereoscopic optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of one optical system in a stereoscopic optical system according to Example 1.

FIG. 2 is an aberration diagram of the one optical system according to Example 1.

FIG. 3 is a sectional view of one optical system in a stereoscopic optical system according to Example 2.

FIG. 4 is an aberration diagram of the one optical system according to Example 2.

FIG. 5 is a sectional view of one optical system in a stereoscopic optical system according to Example 3.

FIG. 6 is an aberration diagram of the one optical system according to Example 3.

FIG. 7 is a sectional view of one optical system in a stereoscopic optical system according to Example 4.

FIG. 8 is an aberration diagram of the one optical system according to Example 4.

FIG. 9 is a sectional view of one optical system in a stereoscopic optical system according to Example 5.

FIG. 10 is an aberration diagram of the one optical system according to Example 5.

FIG. 11 is a top view of a stereoscopic optical system according to each example.

FIG. 12 illustrates two image circles formed by the stereoscopic optical system according to Example 1.

FIG. 13 is a schematic diagram of an image pickup apparatus having the stereoscopic optical system according to any one of each example.

### DETAILED DESCRIPTION

Referring now to the accompanying drawings, a description will be given according to Examples according to the disclosure.

Before Examples 1 to 5 are specifically described, a description will be given of matters common to each example. FIG. 11 illustrates a stereoscopic optical system according to Example 1 as a representative example viewed from above. The stereoscopic optical system according to each example includes a right optical system OSR and a left optical system OSL as two coaxial optical systems arranged in parallel. The right optical system OSR and the left optical system OSL are arranged so that their optical axes extend parallel to each other, separated by a base length D, which is a distance between their optical axes. Each of the right optical system OSR and the left optical system OSL includes an aperture stop (diaphragm) SP. IP represents an image plane. An imaging surface (light receiving surface) of an image sensor or a film surface (photosensitive surface) of a silver film is disposed on the image plane IP.

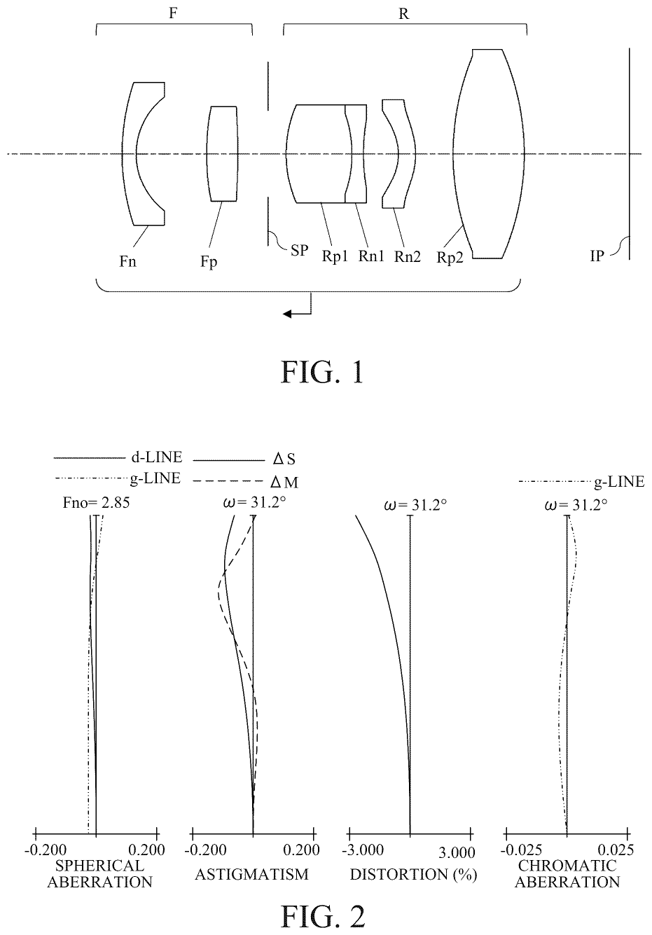

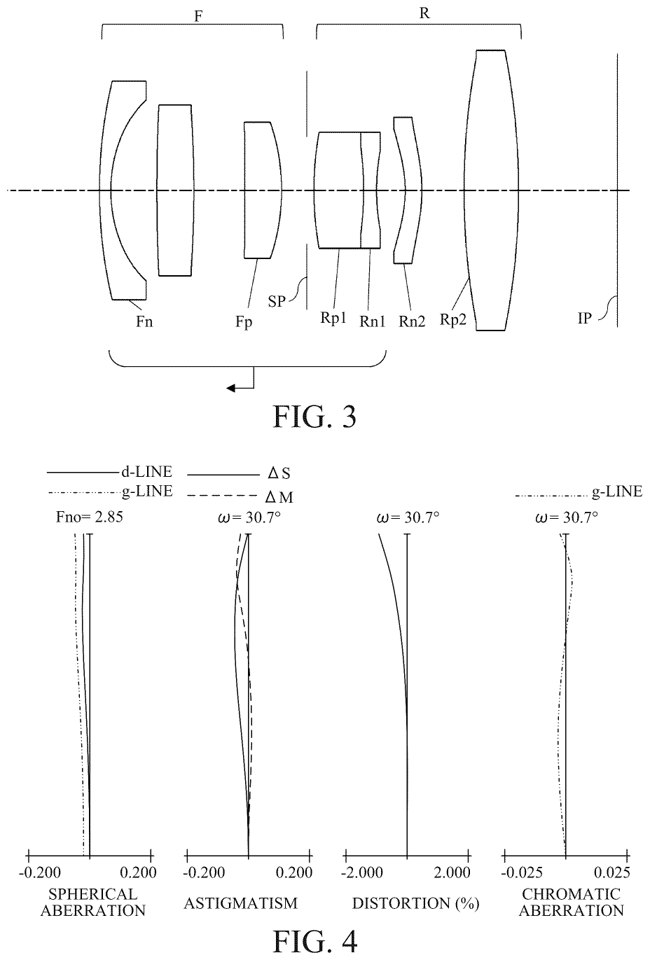

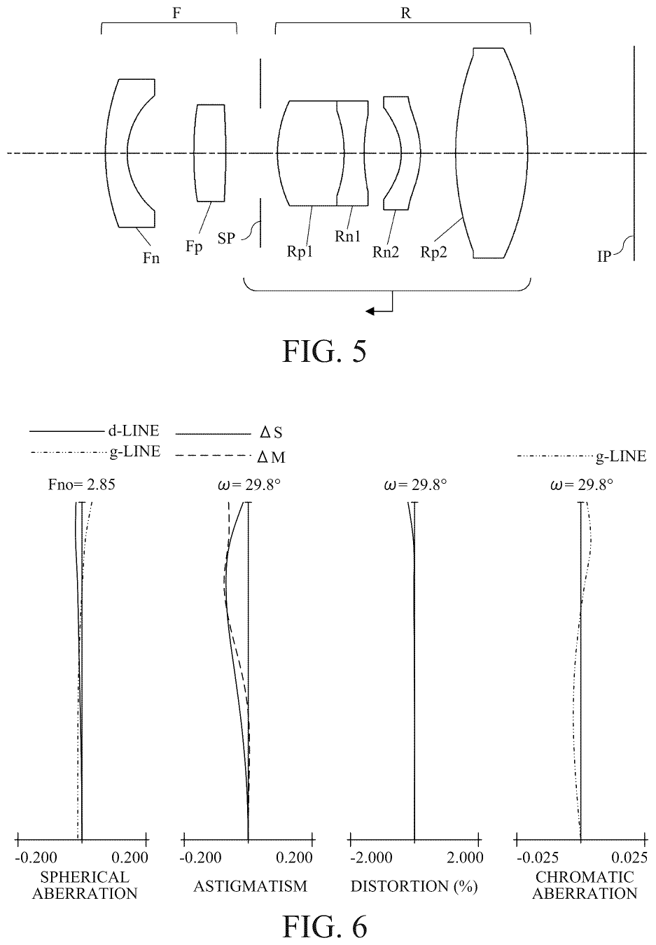

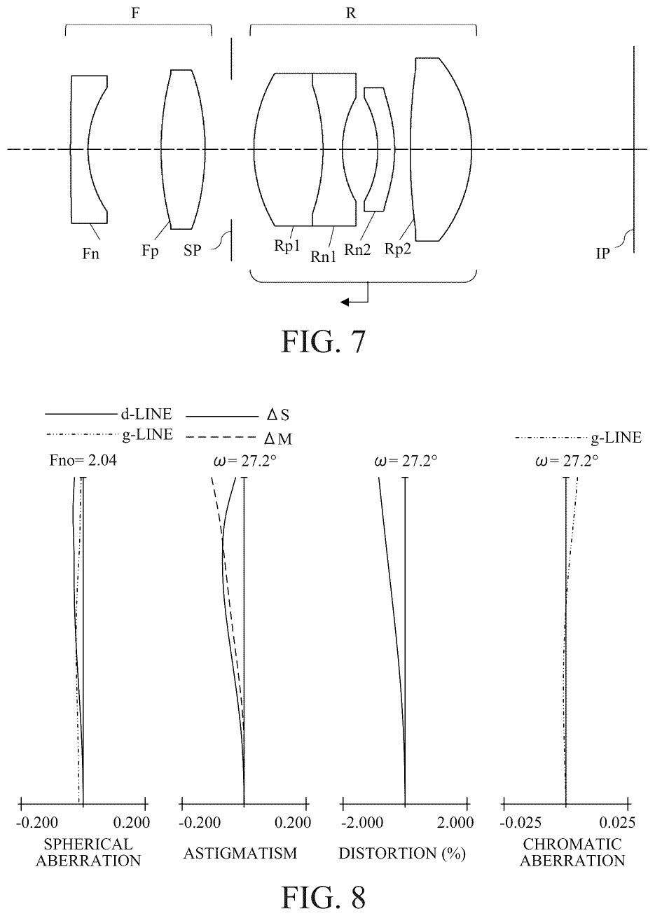

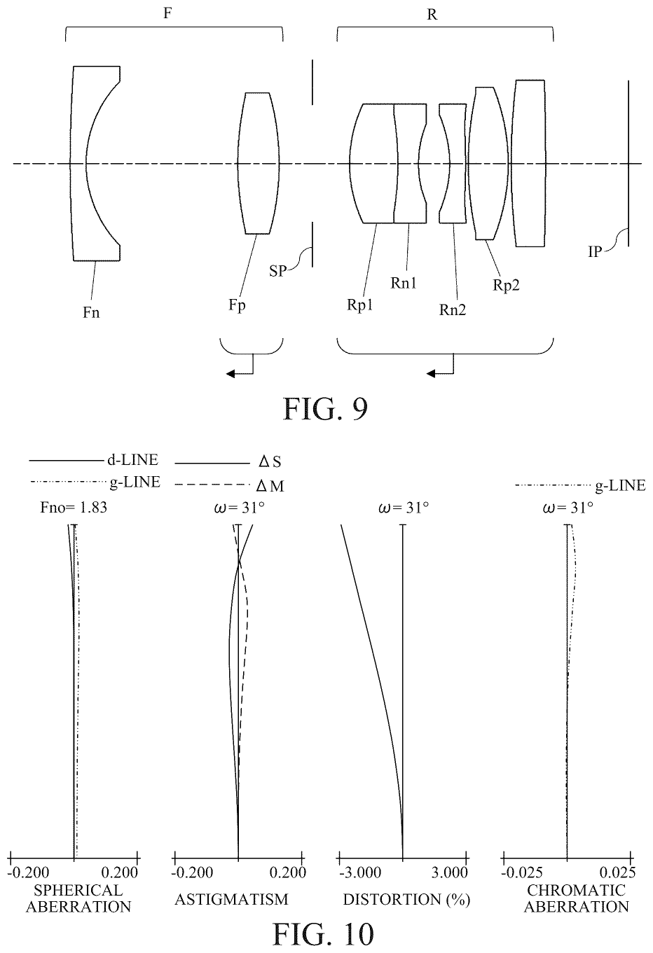

FIGS. 1, 3, 5, 7, and 9 illustrate sections of one of the right optical system OSR and the left optical system OSL in the stereoscopic optical systems according to Examples 1 to 5, respectively, in an in-focus state on an object at infinity (referred to as “in an in-focus state at infinity” hereinafter).

Each optical system (OSR and OSL) includes, in order from the object side to the image side, a front lens unit F, an aperture stop SP, and a rear lens unit R. The rear lens unit R includes at least two positive lenses (a first positive lens Rp1 and a second positive lens Rp2).

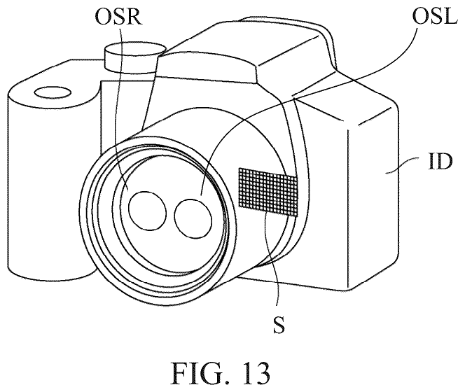

FIG. 12 illustrates an image circle ICR formed on an image plane (e.g., an imaging surface of a single image sensor) IP by the right optical system OSR, and an image circle ICL formed on the same image plane IP by the left optical system OSL. The right image circle ICR and the left image circle ICL are formed side by side on the image plane IP. Thereby, two captured images (a pair of parallax images) can be obtained that have a parallax and can be viewed stereoscopically by an image pickup apparatus such as a digital camera having a single image sensor.

In each example, a negative lens Fn disposed closest to an object in the front lens unit F can achieve a wide-angle optical system. In each optical system, the second positive lens Rp2 disposed closest to the image plane in the rear lens unit R, and negative lenses (first negative lens Rn1 and second negative lens Rn2) disposed on the object side of the second positive lens Rp2 can reduce an incident angle of an off-axis light ray on the image plane (imaging surface of the image sensor) IP. This configuration can reduce color shading that occurs in the image sensor.

In each optical system, the first positive lens Rp1 having high refractive index disposed on the object side of the second positive lens Rp2 that is disposed closest to the image plane in the rear lens unit R can efficiently converge rays while satisfactorily correcting spherical aberration that occurs in the first negative lens Rn1. Thereby, both a large aperture diameter and a compact optical system can be achieved.

In each optical system according to each example, the optical system wholly or partially moves on the optical axis during focusing. In FIGS. 1, 3, 5, 7, and 9, arrows indicate a moving direction of the lenses and aperture stop SP that move during focusing from an object at infinity to an object at a close distance.

Each optical system in each example may satisfy the following inequality (1):

$$1.8 \leq D / ( f tan ω ) ) \leq 5.5 \qquad ( 1 )$$

where D is a base length, f is a focal length of the optical system, and ω is a maximum half angle of view of the optical system.

Inequality (1) defines a proper relationship between the base length and the size of the image sensor to obtain a good three-dimensional effect from two captured images while improving the image quality of each captured image. In a case where the base length D increases so that D/(f tan ω) becomes higher than the upper limit of inequality (1), the size of the image circle on the image sensor becomes so small that the image quality of the captured image lowers. In a case where the base length D reduces so that D/(f tan ω) becomes lower than the lower limit of inequality (1), the three-dimensional effect obtained from the two captured images reduces, the two image circles overlap each other on the image sensor, and a proper parallax image cannot be obtained.

Inequality (1) may be replaced with inequality (1a) below:

$$1.9 \leq D / ( f tan ω ) ) \leq 5. \qquad ( 1 a )$$

Inequality (1) may be replaced with inequality (1b) below:

$$2. \leq D / ( f tan ω ) ) \leq 4.5 \qquad ( 1 b )$$

The above configuration and inequality (1) can achieve a stereoscopic optical system that has a large aperture diameter, high optical performance, and a reduced size and base length, and can provide good stereoscopic imaging.

Each optical system according to each example may satisfy at least one of the following inequalities (2) to (12). In these equations, fF is a focal length of the front lens unit F disposed on the object side of the aperture stop SP, and fR is a focal length of the rear lens unit R disposed on the image side of the aperture stop SP. fRn1 is a focal length of the first negative lens Rn1 that has the strongest refractive power among at least one negative lens included in the rear lens unit R. In the rear lens unit R, fRp2 is a focal length of the second positive lens Rp2 having the strongest refractive power among at least one positive lens disposed on the image side of the first negative lens Rn1. In the rear lens unit R, fRp1 is a focal length of the first positive lens Rp1 having the strongest refractive power among at least one positive lens disposed on the object side of the second lens Rp2.

fFp is a focal length of the positive lens Fp having the strongest refractive power among at least one positive lens included in the front lens unit F. In the front lens unit F, fFn is a focal length of the negative lens Fn having the strongest refractive power disposed on the object side of the positive lens Fp.

R1 is a radius of curvature of an image-side surface of the first negative lens Rn1, and R2 is a radius of curvature of an object-side surface of the second negative lens Rn2 adjacent to and disposed on the image side of the first negative lens Rn1 via an air gap. ndRp1 is a refractive index for the d-line of the material of the first positive lens Rp1. L is a length on the optical axis (overall optical length) from a surface closest to an object (front surface) of the optical system to the image plane IP in an in-focus state at infinity, sk is a back focus of the optical system in an in-focus state at infinity, and t1 is a distance on the optical axis from a front surface of the optical system to an entrance pupil position.

$$- 1. \leq f / fF \leq 1.4 \qquad ( 2 )$$

$$- 0.9 \leq fR / fF \leq 2.4 \qquad ( 3 )$$

$$- 6. \leq fR / fRn 1 \leq - 1.4 \qquad ( 4 )$$

$$- 3.2 \leq fRp 2 / fRn 1 \leq - 1. \qquad ( 5 )$$

$$04 \leq fRp 2 / fRp 1 \leq 4.5 \qquad ( 6 )$$

$$- 2. \leq fFn / fFp \leq - 0.1 \qquad ( 7 )$$

$$- 0.8 \leq ( R 2 + R 1 ) / ( R 2 - R 1 ) \leq 0.3 \qquad ( 8 )$$

$$1.6 \leq ndRp 1 \leq 2.2 \qquad ( 9 )$$

$$2. \leq L / f \leq 5.5 \qquad ( 10 )$$

$$0.3 \leq sk / f \leq 0.9 \qquad ( 11 )$$

$$2 \leq t 1 / f \leq 1.3 \qquad ( 12 )$$

Inequality (2) defines a proper relationship between the focal length of the optical system and the focal length of the front lens unit F by securing the back focus of the optical system and minimizing coma and distortion in the optical system. In a case where the positive refractive power of the front lens unit F increases and f/fF becomes higher than the upper limit of inequality (2), the principal point position of the optical system moves toward the object side, and it becomes difficult to secure the back focus. In a case where the negative refractive power of the front lens unit F increases and f/fF becomes lower than the lower limit of inequality (2), it becomes difficult to correct coma and distortion generated in the rear lens unit R.

Inequality (3) defines a proper relationship between the focal length of the rear lens unit R and the focal length of the front lens unit F in order to reduce the size of the optical system and suppress spherical aberration of the optical system. In a case where the refractive power of the rear lens unit R reduces and fR/fF becomes higher than the upper limit of inequality (3), the overall length of the optical system increases. In a case where the refractive power of the rear lens unit R increases, it becomes difficult to correct spherical aberration that occurs in the rear lens unit R.

Inequality (4) defines a proper relationship between the focal length of the rear lens unit R and the focal length of the first negative lens Rn1 in order to reduce color shading and suppress curvature of field. In a case where the refractive power of the lens Rn1 increases, it becomes difficult to correct curvature of field that occurs in the rear lens unit R. In a case where the refractive power of the first negative lens Rn1 reduces and fR/fRn1 becomes lower than the lower limit of inequality (4), the incident height of the off-axis ray incident on the second positive lens Rp2 reduces, an incident angle of the ray incident on the image sensor increases, and color shading becomes significant.

Inequality (5) defines a proper relationship between the focal length of the second positive lens Rp2 and the focal length of the first negative lens Rn1 in order to suppress coma and distortion that occur in the rear lens unit R and reduce color shading. The refractive power of the second positive lens Rp2 lowers and fRp2/fRn1 becomes higher than the upper limit of the inequality (5), an incident angle of a ray on the image sensor increases, and color shading becomes significant. In a case where the refractive power of the second positive lens Rp2 increases and fRp2/fRn1 becomes lower than the lower limit of inequality (5), it becomes difficult to correct coma and distortion that occur in the second positive lens Rp2.

Inequality (6) defines a proper relationship between the focal length of the second positive lens Rp2 and the focal length of the first positive lens Rp1 in order to reduce the size of the optical system and suppress spherical aberration that occurs in the rear lens unit R. In a case where the refractive power of the first positive lens Rp1 increases and fRp2/fRp1 becomes higher than the upper limit of inequality (6), it becomes difficult to correct spherical aberration generated in the first positive lens Rp1. In a case where the refractive power of the first positive lens Rp1 reduces and fRp2/fRp1 becomes lower than the lower limit of inequality (6), the overall length and the size of the optical system increase.

Inequality (7) defines a proper relationship between the focal length of the negative lens Fn and the focal length of the positive lens Fp in the front lens unit F in order to reduce the size of the optical system and suppress spherical aberration generated in the front lens unit F. In a case where the refractive power of the positive lens Fp increases and fFn/fFp becomes higher than the upper limit of inequality (7), it becomes difficult to correct spherical aberration that occurs in the positive lens Fp. In a case where the refractive power of the positive lens Fp reduces and fFp becomes lower than the lower limit of (7), the overall length and the size of the optical system increase.

Inequality (8) defines a proper range of the shape factor of an air lens between the first negative lens Rn1 and the second negative lens Rn2 in order to suppress curvature of field and coma that occur in the rear lens unit R. In a case where the radius of curvature of the object-side surface of the second negative lens Rn2 increases and (R2+R1)/(R2-R1) becomes higher than the upper limit of inequality (8), it becomes difficult to correct curvature of field that occurs in the rear lens unit R. In a case where the radius of curvature of the object-side surface of the second negative lens Rn2 reduces and (R2+R1)/(R2-R1) becomes lower than the lower limit of the inequality (8), it becomes difficult to correct coma that occurs in the rear lens unit R.

Inequality (9) defines a proper range of the refractive index of the material of the first positive lens Rp1 in order to reduce the size of the optical system and suppress spherical aberration and longitudinal chromatic aberration that occur in the first positive lens Rp1. In a case where the refractive index of the material of the first positive lens Rp1 increases and ndRp1 becomes higher than the upper limit of inequality (9), the dispersion of the lens increases, and it becomes difficult to correct longitudinal chromatic aberration that occurs in the first positive lens Rp1. In a case where the refractive index of the material of the first positive lens Rp1 reduces and ndRp1 becomes lower than the lower limit of inequality (9), the radius of curvature of the surface of the first positive lens Rp1 reduces in order to provide the first positive lens Rp1 with necessary refractive power. On the other hand, in a case where the refractive power of the first positive lens Rp1 is reduced, the convergence of a ray reduces, and the overall length and the size of the optical system increase.

Inequality (10) defines a proper relationship between the overall optical length of the optical system and the focal length of the optical system in order to achieve both a compact optical system and high performance. In a case where the overall optical length of the optical system increases and L/f becomes higher than the upper limit of inequality (10), the size of the optical system increases. In a case where the overall optical length of the optical system reduces and L/f becomes lower than the lower limit of inequality (10), the radius of curvature of each lens surface reduces, high-order aberrations become significant, and high performance of the optical system becomes difficult.

Inequality (11) defines a proper relationship between the back focus of the optical system and the focal length of the optical system in order to reduce the size of the optical system and color shading. In a case where the back focus of the optical system increases and sk/f becomes higher than the upper limit of inequality (11), the overall length and the size of the optical length increase. In a case where the back focus of the optical system reduces and sk/f becomes lower than the lower limit of (11), an incident angle of a ray on the image sensor increases, and color shading becomes significant.

Inequality (12) defines a proper relationship between the distance from the foremost surface of the optical system to the entrance pupil position and the focal length of the optical system in order to suppress coma and distortion in the optical system and reduce the size of the optical system. In a case where the entrance pupil position moves toward the image side and t1/f becomes higher than the upper limit of inequality (12), the diameter of the lens closest to the object increases, and the size of the optical system increases. In a case where the entrance pupil position moves toward the object side and t1/f becomes lower than the lower limit of inequality (12), the negative refractive power of the front lens unit F increases, and it becomes difficult to correct coma and distortion generated in the front lens unit F.

Inequalities (2) through (12) may be replaced with inequalities (2a) to (12a) below:

$$- 0.6 \leq f / fF \leq 1.2 \qquad ( 2 a )$$

$$- 0.7 \leq fR / fF \leq 2.2 \qquad ( 3 a )$$

$$- 5.5 \leq fR / Rn 1 \leq - 1.6 \qquad ( 4 a )$$

$$- 3. \leq fRp 2 / Rn 1 \leq - 1.2 \qquad ( 5 a )$$

$$0.8 \leq fRp 2 / fRp 1 \leq 4. \qquad ( 6 a )$$

$$- 1.6 \leq fFn / fFp \leq - 0.2 \qquad ( 7 a )$$

$$- 0.7 \leq ( R 2 + R 1 ) / ( R 2 - R 1 ) \leq 0.2 \qquad ( 8 a )$$

$$1.7 \leq ndRp 1 \leq 2.1 \qquad ( 9 a )$$

$$2.3 \leq L / f \leq 5. \qquad ( 10 a )$$

$$0.4 \leq sk / f \leq 0.82 \qquad ( 11 a )$$

$$0.3 \leq t 1 / f \leq 1.2 \qquad ( 12 a )$$

Inequalities (2) through (12) may be replaced with inequalities (2b) to (12b) below:

$$- 0.4 \leq f / fF \leq 1. \qquad ( 2 b )$$

$$- 0.5 \leq fR / fF \leq 2.0 \qquad ( 3 b )$$

$$- 5. \leq fR / fRn 1 \leq - 1.8 \qquad ( 4 b )$$

$$- 2.8 \leq fRp 2 / fRn 1 \leq - 1.4 \qquad ( 5 b )$$

$$1. \leq fRp 2 / fRp 1 \leq 3.5 \qquad ( 6 b )$$

$$- 1.2 \leq fFn / fFp \leq - 0.3 \qquad ( 7 b )$$

$$- 0.6 \leq ( R 2 + R 1 ) / ( R 2 - R 1 ) \leq 0.1 \qquad ( 8 b )$$

$$1.8 \leq ndRp 1 \leq 2. \qquad ( 9 b )$$

$$2.6 \leq L / f \leq 4. 5 \qquad ( 10 b )$$

$$0.5 \leq sk / f \leq 0. 7 \qquad ( 11 b )$$

$$0. 4 \leq t 1 / f \leq 1.1 \qquad ( 12 b )$$

The optical systems according to Examples 1 to 5 will now be specifically described.

Examples 1, 3, 4, and 5, the front lens unit F includes, in order from the object side, a negative lens Fn and a positive lens Fp. In Example 2, the front lens unit F includes, in order from the object side, a negative lens Fn and a positive lens Fp. The rear lens unit R includes a negative lens Fn, a positive lens, and a positive lens Fp.

In Examples 1, 2, 3, and 4, the rear lens unit R includes, in order from the object side, a cemented lens in which a first positive lens Rp1 and a first negative lens Rn1 are cemented together, a second negative lens Rn2, and a second positive lens Rp2. In Example 5, the rear lens unit R includes, in order from the object side, a cemented lens in which a first positive lens Rp1 and a first negative lens Rn1 are cemented together, a second negative lens Rn2, a second positive lens Rp2, and a third positive lens. As described above, the optical system according to each example includes six or more lenses (while a cemented lens in which two lenses are cemented together is counted as two lenses).

As in each example, a negative lens disposed closest to the object can achieve a wide angle of the optical system.

The rear lens unit R including a first negative lens Rn1 and a second positive lens Rp2 on the image side of the first negative lens Rn1 can reduce the incident angle of an off-axis ray on the image sensor. Thereby, color shading can be reduced.

The first positive lens Rp1 made of a material with a high refractive index and disposed on the object side of the second positive lens Rp2 in the rear lens unit R can reduce the size of the optical system by effectively converging a ray and by satisfactorily correcting spherical aberration generated by the first negative lens Rn1. Moreover, the second positive lens Rp2 adjacent to and disposed on the image side of the first negative lens Rn1 via an air gap can satisfactorily correct coma and curvature of field that occur in the rear lens unit R. Thereby, a reduced size and a large aperture diameter of the optical system can be achieved.

Regarding focusing, Example 1 adopts the entire moving method that moves the entire optical system toward the object during focusing from an object at infinity to an object at a close distance. Example 2 adopts a front focus method that integrally moves a subunit that includes a lens closest to an object in the optical system during focusing (the front lens unit F, the aperture stop SP, and the first positive lens Rp1 and the first negative lens Rn1 in the rear lens unit R) toward the object side. Examples 3 and 4 use a rear focus method that integrally moves a subunit including a lens closest to an image plane in the optical system during focusing. In Example 3, the aperture stop SP and the rear lens unit R move together toward the object side, and in Example 4, the rear lens unit R moves toward the object side. Example 5 employs a floating focus system that moves two different subunits in the optical system (the positive lens Fp in the front lens unit F and the rear lens unit R) with different loci toward the object side during focusing.

Numerical examples 1 to 5 corresponding to Examples 1 to 5 will now be illustrated. In each numerical example, a surface number indicates the order of a surface from the object side. r represents a radius of curvature (mm) of an i-th surface, d represents a lens thickness or air gap (mm) on the optical axis between i-th and (i+1)-th surfaces. nd represents a refractive index for the d-line of an optical material between i-th and (i+1)-th surfaces, νd represents an Abbe number based on the d-line of the optical material, and an effective diameter is a ray effective diameter of an i-th surface.

The Abbe number νd based on the d-line is expressed as follows:

$$v d = ( n d - 1 ) / ( n F - n C )$$

where nd, nF, and nC are refractive indices for the d-line (587.6 nm), F-line (486.1 nm), and C-line (656.3 nm) in the Fraunhofer line, respectively.

BF represents a back focus (mm). The back focus is a distance on an optical axis from a lens surface (final surface) closest to the image plane of the optical system to a paraxial image plane, and expressed in terms of an air equivalent length. An overall lens length (mm) is a distance on the optical axis from the foremost surface to the final surface of the optical system plus the back focus, which corresponds to the overall optical length.

An asterisk “*” next to a surface number indicates that the lens surface has an aspheric shape. The aspheric shape is expressed by the following equation:

$$x = ( {h}^{2} / R ) {/ [ 1 + \{ 1 - ( 1 + K ) {( h / R )}^{2} \} ]}^{1 / 2} + A 4 \times {h}^{4} + A 6 \times {h}^{6} + A 8 \times {h}^{8} + A 8 \times {h}^{8} + A 10 \times {h}^{10}$$

where x is a displacement amount from a surface vertex in the optical axis direction, h is a height from the optical axis in a direction perpendicular to the optical axis, a light traveling direction is positive, R is a paraxial radius of curvature, K is a conic constant, and A4, A6, A8, and A10 are aspheric coefficients. The “e±M” in the conic constant and aspheric coefficients means×10^{±M}.

Table 1 summarizes values of inequalities (1) to (12) in numerical examples 1 to 5. The optical system according to each numerical example satisfies all of inequalities (1) to (12).

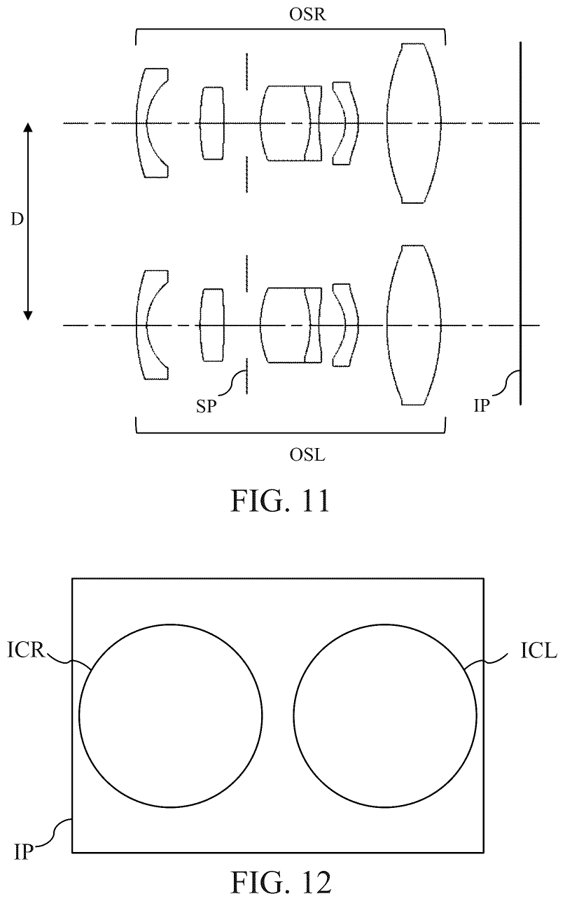

FIGS. 2, 4, 6, 8 and 10 respectively illustrate longitudinal aberrations (spherical aberration, astigmatism, distortion, and chromatic aberration) of the optical systems according to numerical examples 1 to 5. In the spherical aberration diagram, Fno indicates an F-number. A solid line indicates a spherical aberration amount for the d-line (wavelength 587.6 nm), and an alternate long and two short dashes line indicates a spherical aberration amount for the g-line (wavelength 435.8 nm). In the astigmatism diagram, a broken line ΔM indicates an astigmatism amount on a sagittal image plane, and a broken line ΔM indicates an astigmatism amount on a meridional image plane. The distortion diagram illustrates a distortion amount for the d-line. The chromatic aberration diagram illustrates a lateral chromatic aberration amount for the g-line. ω is a half angle of view (°).

### Numerical Example 1

UNIT: mm

SURFACE DATA

| Surface No. | r | d | nd | vd | Effective Diameter |
|---|---|---|---|---|---|
| 1 | 16.997 | 1.07 | 1.49700 | 81.54 | 9.68 |
| 2 | 5.396 | 5.36 | | | 7.68 |
| 3* | 22.689 | 2.36 | 1.53160 | 55.84 | 6.22 |
| 4* | −53.190 | 2.31 | | | 6.38 |
| 5 (SP) | ∞ | 1.35 | | | 6.53 |
| 6 | 9.291 | 5.00 | 1.81600 | 46.62 | 6.66 |
| 7 | −9.291 | 0.87 | 1.69895 | 30.13 | 5.46 |
| 8 | 15.129 | 2.65 | | | 4.90 |
| 9* | −3.947 | 1.30 | 1.63550 | 23.89 | 5.94 |
| 10* | −5.679 | 2.86 | | | 7.28 |
| 11 | 19.265 | 5.40 | 1.53775 | 74.70 | 13.63 |
| 12 | −19.265 | (Variable) | | | 14.66 |
| Image Plane | ∞ | | | | |

ASPHERIC DATA
3rd Surface
K = 0.00000e+000 A 4 = 3.42924e−004 A 6 = 5.40239e−008 A 8 = 7.15673e−007
4th Surface
K = 0.00000e+000 A 4 = −2.06201e−005 A 6 = −3.16817e−006 A 8 = 7.24155e−007
9th Surface
K = 0.00000e+000 A 4 = 2.41018e−003 A 6 = 1.49517e−004 A 8 = 7.38145e−006
A10 = −8.67755e−007 A12 = 7.20535e−008
10th Surface
K = 0.00000e+000 A 4 = 1.79265e−003 A 6 = 7.50567e−005 A 8 = 2.80419e−007
VARIOUS DATA

| | |
|---|---|
| Focal Length | 13.20 |
| Fno | 2.85 |
| Half Angle of View (°) | 31.23 |
| Image Height | 8.00 |
| Overall Lens Length | 38.54 |
| BF | 8.00 |

SINGLE LENS DATA

| Lens | Starting Surface | Focal Length |
|---|---|---|
| 1 | 1 | −16.41 |
| 2 | 3 | 30.25 |
| 3 | 6 | 6.48 |
| 4 | 7 | −8.12 |
| 5 | 9 | −28.77 |
| 6 | 11 | 18.84 |

### Numerical Example 2

UNIT: mm

SURFACE DATA

| Surface No. | r | d | nd | vd | Effective Diameter |
|---|---|---|---|---|---|
| 1 | 20.324 | 0.92 | 1.59522 | 67.74 | 11.74 |
| 2 | 6.338 | 3.74 | | | 9.57 |
| 3 | 80.516 | 3.00 | 1.89286 | 20.36 | 8.99 |
| 4 | −49.602 | 4.11 | | | 8.35 |
| 5* | 456.535 | 3.00 | 1.53160 | 55.84 | 6.87 |
| 6* | −9.213 | 2.05 | | | 7.14 |
| 7 (SP) | ∞ | 0.57 | | | 6.35 |
| 8 | 14.220 | 4.03 | 1.88300 | 40.76 | 6.10 |
| 9 | −14.220 | 1.05 | 1.89286 | 20.36 | 4.85 |
| 10 | 9.514 | 2.32 | | | 4.32 |
| 11* | −5.492 | 1.35 | 1.63550 | 23.89 | 6.41 |
| 12* | −7.258 | 3.42 | | | 7.73 |
| 13 | 30.818 | 4.42 | 1.96300 | 24.11 | 14.50 |
| 14 | −30.818 | (Variable) | | | 15.28 |
| Image Plane | ∞ | | | | |

ASPHERIC DATA
5th Surface
K = 0.00000e+000 A 4 = −1.20930e−004 A 6 = −1.54004e−006 A 8 = 3.10157e−008
6th Surface
K = 0.00000e+000 A 4 = −1.80501e−005 A 6 = −1.39998e−006 A 8 = 5.23245e−008
11th Surface
K = 0.00000e+000 A 4 = 2.37707e−003 A 6 = −1.46625e−005 A 8 = 7.89300e−006
A10 = −6.07443e−007 A12 = 1.31406e−008
12th Surface
K = 0.00000e+000 A 4 = 1.61376e−003 A 6 = 6.13982e−006 A 8 = 1.14249e−006
A10 = −7.30382e−008 A12 = 8.76937e−010
VARIOUS DATA

| | |
|---|---|
| Focal Length | 13.50 |
| Fno | 2.85 |
| Half Angle of View (°) | 30.65 |
| Image Height | 8.00 |
| Overall Lens Length | 41.99 |
| BF | 8.00 |

SINGLE LENS DATA

| Lens | Starting Surface | Focal Length |
|---|---|---|
| 1 | 1 | −15.87 |
| 2 | 3 | 34.75 |
| 3 | 5 | 17.03 |
| 4 | 8 | 8.63 |
| 5 | 9 | −6.25 |
| 6 | 11 | −50.53 |
| 7 | 13 | 16.59 |

### Numerical Example 3

UNIT: mm

SURFACE DATA

| Surface No. | r | d | nd | vd | Effective Diameter |
|---|---|---|---|---|---|
| 1 | 15.477 | 1.64 | 1.49700 | 81.54 | 9.97 |
| 2 | 5.491 | 5.01 | | | 7.64 |
| 3* | 34.014 | 2.38 | 1.53160 | 55.84 | 6.20 |
| 4* | −57.423 | 2.62 | | | 6.42 |
| 5 (SP) | ∞ | 1.27 | | | 6.73 |
| 6 | 8.900 | 5.00 | 1.81600 | 46.62 | 6.95 |
| 7 | −9.441 | 1.50 | 1.69895 | 30.13 | 5.75 |
| 8 | 14.193 | 2.79 | | | 4.93 |
| 9* | −4.372 | 1.44 | 1.63550 | 23.8 | 6.02 |
| 10* | −6.443 | 2.64 | | | 7.54 |
| 11 | 20.670 | 5.40 | 1.53775 | 74.70 | 13.47 |
| 12 | −17.749 | (Variable) | | | 14.59 |
| Image Plane | ∞ | | | | |

ASPHERIC DATA
3rd Surface
K = 0.00000e+000 A 4 = 3.82508e−004 A 6 = −4.13980e−006 A 8 = 1.12882e−006
A10 = −3.79296e−008 A12 = 7.27467e−010
4th Surface
K = 0.00000e+000 A 4 = 4.87047e−005 A 6 = −7.07670e−006 A 8 = 1.06393e−006
A10 = −5.13271e−008 A12 = 1.69678e−009
9th Surface
K = 0.00000e+000 A 4 = 9.24841e−004 A 6 = 6.23435e−005 A 8 = 7.91063e−006
A10 = −3.42356e−007 A12 = 1.27129e−008
10th Surface
K = 0.00000e+000 A 4 = 9.90906e−004 A 6 = 3.91752e−005 A 8 = 1.59837e−006
A10 = −2.31958e−009 A12 = −1.36600e−009
VARIOUS DATA

| | |
|---|---|
| Focal Length | 13.94 |
| Fno | 2.85 |
| Half Angle of View | 29.84 |
| Image Height | 8.00 |
| Overall Lens Length | 39.68 |
| BF | 8.00 |

SINGLE LENS DATA

| Lens | Starting Surface | Focal Length |
|---|---|---|
| 1 | 1 | −18.11 |
| 2 | 3 | 40.55 |
| 3 | 6 | 6.40 |
| 4 | 7 | −7.91 |
| 5 | 9 | −29.34 |
| 6 | 11 | 18.68 |

### Numerical Example 4

UNIT: mm

SURFACE DATA

| Surface No. | r | d | nd | vd | Effective Diameter |
|---|---|---|---|---|---|
| 1 | 174.301 | 1.20 | 1.52841 | 76.46 | 9.02 |
| 2 | 7.436 | 5.00 | | | 7.58 |
| 3* | 20.936 | 3.00 | 1.53160 | 55.84 | 9.35 |
| 4* | −17.572 | 1.81 | | | 9.66 |
| 5 (SP) | ∞ | 1.53 | | | 9.49 |
| 6 | 10.065 | 4.73 | 1.81600 | 46.62 | 9.30 |
| 7 | −13.587 | 1.33 | 1.70585 | 30.24 | 7.82 |
| 8 | 7.179 | 2.42 | | | 6.31 |
| 9* | −7.166 | 1.16 | 1.63550 | 23.89 | 6.32 |
| 10* | −9.575 | 1.06 | | | 7.50 |
| 11 | 40.577 | 4.20 | 1.53775 | 74.70 | 10.01 |
| 12 | −9.716 | (Variable) | | | 11.29 |
| Image Plane | ∞ | | | | |

ASPHERIC DATA
3rd Surface
K = 0.00000e+000 A 4 = 4.92834e−005 A 6 = −7.58139e−007 A 8 = 9.66877e−009
A10 = 5.28887e−010 A12 = −3.82528e−011
4th Surface
K = 0.00000e+000 A 4 = −2.87709e−005 A 6 = −1.94063e−006 A 8 = 1.07057e−008
A10 = 6.57759e−010 A12 = −3.75875e−011
9th Surface
K = 0.00000e+000 A 4 = 1.26314e−004 A 6 = −2.69131e−005 A 8 = 9.33030e−007
A10 = 8.34209e−008 A12 = −5.77848e−009
10th Surface
K = 0.00000e+000 A 4 = 4.86267e−004 A 6 = −4.20015e−006 A 8 = 8.70440e−007
A10 = −6.49799e−009 A12 = −5.42622e−011
VARIOUS DATA

| | |
|---|---|
| Focal Length | 13.61 |
| Fno | 2.04 |
| Half Angle of View (°) | 27.21 |
| Image Height | 7.00 |
| Overall Lens Length | 38.54 |
| BF | 11.11 |

SINGLE LENS DATA

| Lens | Starting Surface | Focal Length |
|---|---|---|
| 1 | 1 | −14.74 |
| 2 | 3 | 18.47 |
| 3 | 6 | 7.79 |
| 4 | 7 | −6.48 |
| 5 | 9 | −55.09 |
| 6 | 11 | 15.02 |

### Numerical Example 5

UNIT: mm

SURFACE DATA

| Surface No. | r | d | nd | vd | Effective Diameter |
|---|---|---|---|---|---|
| 1 | 99.659 | 1.15 | 1.49700 | 81.54 | 12.92 |
| 2 | 8.360 | 11.00 | | | 10.61 |
| 3* | 21.148 | 3.00 | 1.58313 | 59.38 | 9.05 |
| 4* | −19.042 | 2.43 | | | 9.15 |
| 5 (SP) | ∞ | 2.68 | | | 8.47 |
| 6 | 9.955 | 3.50 | 1.88300 | 40.76 | 7.68 |
| 7 | −22.499 | 1.50 | 1.80518 | 25.42 | 6.41 |
| 8 | 7.650 | 2.27 | | | 5.22 |
| 9* | −7.831 | 1.14 | 1.63550 | 23.89 | 6.26 |
| 10* | −36.815 | 0.20 | | | 7.72 |
| 11 | 23.602 | 2.90 | 1.81554 | 44.36 | 8.96 |
| 12 | −14.497 | 0.21 | | | 9.89 |
| 13 | 49.278 | 2.49 | 1.88300 | 40.76 | 10.53 |
| 14 | −200.014 | (Variable) | | | 10.83 |
| Image Plane | ∞ | | | | |

ASPHERIC DATA
3rd Surface
K = 0.00000e+000 A 4 = −3.31939e−005 A 6 = 1.00057e−007 A 8 = −2.74914e−008
4th Surface
K = 0.00000e+000 A 4 = −2.85162e−005 A 6 = 1.59757e−007 A 8 = −2.80716e−008
9th Surface
K = 0.00000e+000 A 4 = 7.25303e−004 A 6 = −1.24640e−005 A 8 = 8.86812e−007
A10 = −7.98689e−008
10th Surface
K = 0.00000e+000 A 4 = 1.09100e−003 A 6 = −9.24396e−006 A 8 = −6.60088e−008
A10 = 3.33401e−009
VARIOUS DATA

| | |
|---|---|
| Focal Length | 10.00 |
| Fno | 1.83 |
| Half Angle of View (°) | 30.96 |
| Image Height | 6.00 |
| Overall Lens Length | 40.48 |
| BF | 6.00 |

SINGLE LENS DATA

| Lens | Starting Surface | Focal Length |
|---|---|---|
| 1 | 1 | −18.44 |
| 2 | 3 | 17.67 |
| 3 | 6 | 8.23 |
| 4 | 7 | −6.94 |
| 5 | 9 | −15.89 |
| 6 | 11 | 11.40 |
| 7 | 13 | 44.99 |

| | Numerical Example | | | | |
|---|---|---|---|---|---|
| | 1 | 2 | 3 | 4 | 5 |
| D/(f · tanω) | 2.500 | 2.500 | 2.250 | 3.143 | 4.000 |
| f/fF | −0.222 | 0.800 | −0.332 | 0.116 | 0.391 |
| fR/fF | −0.282 | 1.707 | −0.396 | 0.170 | 0.731 |
| fR/fRn1 | −2.067 | −4.604 | −2.105 | −3.080 | −2.699 |
| fRp2/fRn1 | −2.321 | −2.652 | −2.362 | −2.316 | −1.644 |
| fRp2/fRp1 | 2.908 | 1.923 | 2.919 | 1.929 | 1.385 |
| fFn/fFp | −0.543 | −0.932 | −0.447 | −0.798 | −1.043 |
| (R2 + R1)/(R2 − R1) | −0.586 | −0.268 | −0.529 | −0.001 | 0.012 |
| ndRp1 | 1.816 | 1.883 | 1.816 | 1.816 | 1.883 |
| L/f | 2.920 | 3.110 | 2.846 | 2.832 | 4.048 |
| sk/f | 0.606 | 0.593 | 0.574 | 0.816 | 0.600 |
| t1/f | 0.532 | 0.666 | 0.557 | 0.478 | 0.943 |
| D | 20.000 | 20.000 | 18.000 | 22.000 | 24.000 |
| f | 13.196 | 13.500 | 13.944 | 13.613 | 10.000 |
| ω | 31.226 | 30.651 | 29.844 | 27.215 | 30.964 |
| fR | 16.776 | 28.790 | 16.641 | 19.966 | 18.719 |
| fFn/fFp | −59.418 | 16.869 | −42.000 | 117.190 | 25.605 |
| fRn | −8.116 | −6.254 | −7.906 | −6.483 | −6.936 |
| fRpr | 18.835 | 16.585 | 18.675 | 15.016 | 11.402 |
| fRpf | 6.476 | 8.626 | 6.398 | 7.785 | 8.232 |
| fFn | −16.412 | −15.866 | −18.109 | −14.735 | −18.437 |
| fFp | 30.245 | 17.027 | 40.549 | 18.471 | 17.669 |
| L | 38.537 | 41.988 | 39.680 | 38.545 | 40.476 |
| sk | 8.000 | 8.000 | 8.002 | 11.110 | 6.000 |
| t1 | 7.023 | 8.988 | 7.765 | 6.507 | 9.435 |

### Image Pickup Apparatus

FIG. 13 illustrates an image pickup apparatus (digital still camera) using any one of the stereoscopic optical systems according to Examples 1 to 5. In FIG. 13, ID represents a camera body, and SO represents the imaging optical system SO including one of the stereoscopic optical systems according to Examples 1 to 5 (the right optical system OSR and the left optical system OSL). The imaging optical system SO may be attachable to and detachable from or integrated with the camera body ID. S represents an image sensor such as a CCD sensor or CMOS sensor that is built into the camera body ID and photoelectrically converts the optical image formed by the imaging optical system SO (i.e., captures an object).

The image pickup apparatus may be a single-lens reflex camera with a quick-turn mirror, or a mirrorless camera without a quick-turn mirror.

The image pickup apparatus using the stereoscopic optical system according to any one of Examples 1 to 5 as its imaging optical system can obtain a bright image with a good three-dimensional effect and a reduced overall size.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide a stereoscopic optical system that has a reduced size and a large aperture, and can perform imaging with a good three-dimensional effect.

This application claims priority to Japanese Patent Application No. 2023-213506, which was filed on Dec. 19, 2023, and which is hereby incorporated by reference herein in its entirety.

What is claimed is:

1. A stereoscopic optical system comprising:
two optical systems arranged in parallel,
wherein each of the two optical systems includes an aperture stop and at least two positive lenses disposed on an image side of the aperture stop, and
wherein the following inequalities are satisfied:
$$1.8 \leq D / ( f tan ω ) \leq 5.5$$
$$2. \leq L / f \leq 5.5$$
where D is a distance between optical axes of the two optical systems, f is a focal length of each of the two optical systems, ω is a maximum half angle of view of each of the two optical systems, and L is a distance on an optical axis from a surface closest to an object of each of the two optical systems to an image plane.

2. The stereoscopic optical system according to claim 1, wherein each of the two optical systems includes a front lens unit on an object side of the aperture stop, and
wherein the following inequality is satisfied:
$$- 1. \leq f / fF \leq 1.4$$
where fF is a focal length of the front lens unit.

3. The stereoscopic optical system according to claim 1, wherein each of the two optical systems includes a rear lens unit on the image side of the aperture stop, and
wherein the following inequality is satisfied:
$$- 0.9 \leq fR / fF \leq 2.4$$
where fR is a focal length of the rear lens unit.

4. The stereoscopic optical system according to claim 1, wherein each of the two optical systems includes a rear lens unit on the image side of the aperture stop, and
wherein the following inequality is satisfied:
$$- 6.0 \leq fR / Rn 1 \leq - 1.4$$
where fRn1 is a focal length of a first negative lens having the strongest refractive power among at least one negative lens included in the rear lens unit.

5. The stereoscopic optical system according to claim 4, wherein the following inequality is satisfied:
$$- 3.2 \leq fRp 2 / fRn 1 \leq - 1.$$
where fRp2 is a focal length of a second positive lens having the strongest refractive power among at least one positive lens disposed on the image side of the first negative lens in the rear lens unit.

6. The stereoscopic optical system according to claim 5, wherein the following inequality is satisfied:
$$0.4 \leq fRp 2 / fRp 1 \leq 4.5$$
where fRp1 is a focal length of a first positive lens having the strongest refractive power among at least one positive lens disposed on an object side of the second positive lens in the rear lens unit.

7. The stereoscopic optical system according to claim 1, wherein each of the two optical systems includes a front lens unit on an object side of the aperture stop, and
wherein the following inequality is satisfied:
$$- 2.0 \leq fFn / fFp \leq - 0.1$$
where fFn is a focal length of a negative lens having the strongest refractive power among at least one negative lens included in the front lens unit, and fFp is a focal length of the positive lens having the strongest refractive power among at least one positive lens included in the front lens unit.

8. The stereoscopic optical system according to claim 1, wherein each of the two optical systems includes a rear lens unit on the image side of the aperture stop, and
wherein the following inequality is satisfied:
$$- 0.8 \leq ( R 2 + R 1 ) / ( R 2 - R 1 ) \leq 0.3$$
where R1 is a radius of curvature of an image-side surface of a first negative lens having the strongest refractive power among at least one negative lens included in the rear lens unit, and R2 is a radius of curvature of an object-side surface of a second negative lens adjacent to and disposed on the image side of the first negative lens via an air gap.

9. The stereoscopic optical system according to claim 6, wherein the following inequality is satisfied:
$$1. 6 \leq ndRp 1 \leq 2.2$$
where ndRp1 is a refractive index for d-line of a material of the first positive lens.

10. The stereoscopic optical system according to claim 1, wherein the following inequality is satisfied:
$$0.3 \leq sk / f \leq 0.9$$
where sk is a back focus of each of the two optical systems.

11. The stereoscopic optical system according to claim 1, wherein the following inequality is satisfied:
$$0.2 \leq t 1 / f \leq 1.3$$
where t1 is a distance on an optical axis from a surface closest to an object of each of the two optical systems to an entrance pupil position.

12. The stereoscopic optical system according to claim 1, wherein each of the two optical system includes six or more lenses.

13. The stereoscopic optical system according to claim 1, wherein each of the two optical systems includes a positive lens closest to an image plane.

14. The stereoscopic optical system according to claim 1, wherein each of the two optical systems includes a negative lens closest to an object.

15. The stereoscopic optical system according to claim 1, wherein each of the two optical systems includes at least one lens that moves during focusing.

16. The stereoscopic optical system according to claim 1, wherein two optical images formed by the two optical systems are formed on a single image sensor.

17. The stereoscopic optical system according to claim 1, wherein in each of the two optical systems, a front lens unit disposed on an object side of the aperture stop includes, in order from the object side to the image side, a negative lens and a positive lens, and
wherein a rear lens unit disposed on the image side of the aperture stop includes, in order from the object side to the image side, a cemented lens in which a first positive lens and a first negative lens are cemented together, a second negative lens, and a second positive lens.

18. The stereoscopic optical system according to claim 1, wherein in each of the two optical systems, a front lens unit disposed on an object side of the aperture stop includes, in order from the object side to the image side, a negative lens, a positive lens, and a positive lens, and
wherein a rear lens unit disposed on the image side of the aperture stop includes, in order from the object side to the image side, a cemented lens in which a first positive lens and a first negative lens are cemented together, a second negative lens, and a second positive lens.

19. The stereoscopic optical system according to claim 1, wherein in each of the two optical systems, a front lens unit disposed on an object side of the aperture stop includes, in order from the object side to the image side, a negative lens and a positive lens, and
wherein a rear lens unit disposed on the image side of the aperture stop includes, in order from the object side to the image side, a cemented lens in which a first positive lens and a first negative lens are cemented together, a second negative lens, a second positive lens, and a third positive lens.

20. An image pickup apparatus comprising:
a stereoscopic optical system; and
an image sensor for capturing an object image through the stereoscopic optical system,
wherein the stereoscopic optical system includes:
two optical systems arranged in parallel,
wherein each of the two optical systems includes an aperture stop and at least two positive lenses disposed on an image side of the aperture stop, and
wherein the following inequalities are satisfied:
$$1.8 \leq D / ( f tan ω ) \leq 5.5$$
$$2. \leq L / f \leq 5.5$$
where D is a distance between optical axes of the two optical systems, f is a focal length of each of the two optical systems, ω is a maximum half angle of view of each of the two optical systems, and L is a distance on an optical axis from a surface closest to an object of each of the two optical systems to an image plane.
